(19) United States
(12) Patent Application Publication
(10) Pub. No.: US 2010/0048182 A1
(43) Pub. Date: Feb. 25, 2010

(54) Reaching a Communications Service Subscriber Who is Not Answering an Incoming Communications Request

(76) Inventors: Shay Ben-David, Haifa (IL); Itzhack Goldberg, Hadera (IL); Boaz Mizrachi, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 12/197,329

(22) Filed: Aug. 25, 2008

(51) Int. Cl. H04Q 7/38; H04M 1/00; H04M 3/42

(52) U.S. Cl. 455/414.1; 455/567; 455/466

(57) ABSTRACT

A method for reaching a communications service subscriber who does not answer an incoming communications request to the subscriber's communications device, the method including detecting that an incoming communications request received at a first communications device is not answered, locating a second communications device within a predefined distance from the first communications device, and sending a message to the second communications device indicating the receipt of the incoming communications request at the first communications device.

### FIELD OF THE INVENTION

The present invention relates to communications in general, and in particular to wireless communication with communications service subscribers.

### BACKGROUND OF THE INVENTION

It is often frustrating to cell phone users, and to those who wish to contact them, when a call that is placed to a cell phone subscriber goes unanswered because the subscriber doesn't hear his or her cell phone ring or feel it vibrate. It would therefore be advantageous to let an otherwise inattentive cell phone subscriber know that someone is trying to call him or her on their cell phone.]

### SUMMARY OF THE INVENTION

The present invention in embodiments thereof discloses novel systems and methods for reaching a communications service subscriber who does not answer an incoming communications request made to the subscriber's communications device.

In one aspect of the present invention a method is provided for reaching a communications service subscriber who does not answer an incoming communications request to the subscriber's communications device, the method including detecting that an incoming communications request received at a first communications device is not answered, locating a second communications device within a predefined distance from the first communications device, and sending a message to the second communications device indicating the receipt of the incoming communications request at the first communications device.

In another aspect of the present invention a system is provided for reaching a communications service subscriber who does not answer an incoming communications request to the subscriber's communications device, the system including a detector configured to detect that an incoming communications request received at a first communications device is not answered, a locator configured to locate a second communications device within a predefined distance from the first communications device, and a message sender configured to send a message to the second communications device indicating the receipt of the incoming communications request at the first communications device.

In another aspect of the present invention a computer-implemented program is provided embodied on a computer-readable medium, the computer program including a code segment operative to detect that an incoming communications request received at a first communications device is not answered, a code segment operative to locate a second communications device within a predefined distance from the first communications device, and a code segment operative to send a message to the second communications device indicating the receipt of the incoming communications request at the first communications device.

### BRIEF DESCRIPTION OF THE DRAWINGS

The present invention in embodiments thereof will be understood and appreciated more fully from the following detailed description taken in conjunction with the appended drawings in which:

FIG. 1 is a simplified illustration of a system for reaching a communications service subscriber who does not answer an incoming communications request made to the subscriber's communications device, constructed and operative in accordance with an embodiment of the present invention;

FIG. 2 is a simplified conceptual illustration of an exemplary method of operation of the system of FIG. 1, operative in accordance with an embodiment of the invention;

FIG. 3 is a simplified illustration of a system for reaching a communications service subscriber who does not answer an incoming communications request made to the subscriber's communications device, constructed and operative in accordance with an embodiment of the present invention;

FIG. 4 is a simplified conceptual illustration of an exemplary method of operation of the system of FIG. 3, operative in accordance with an embodiment of the invention; and

FIG. 5 is a simplified block diagram illustration of an exemplary hardware implementation of a computing system, constructed and operative in accordance with an embodiment of the present invention.

### DETAILED DESCRIPTION OF THE INVENTION

The present invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

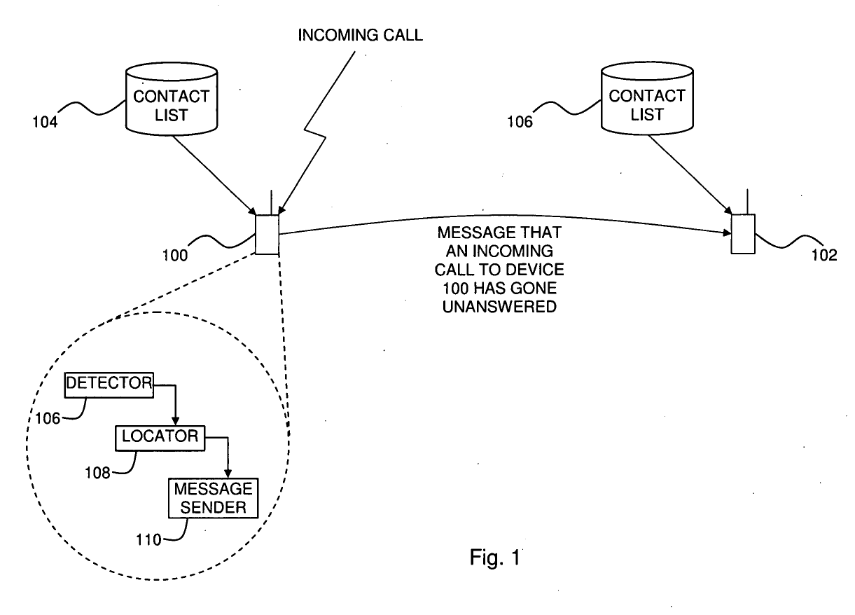

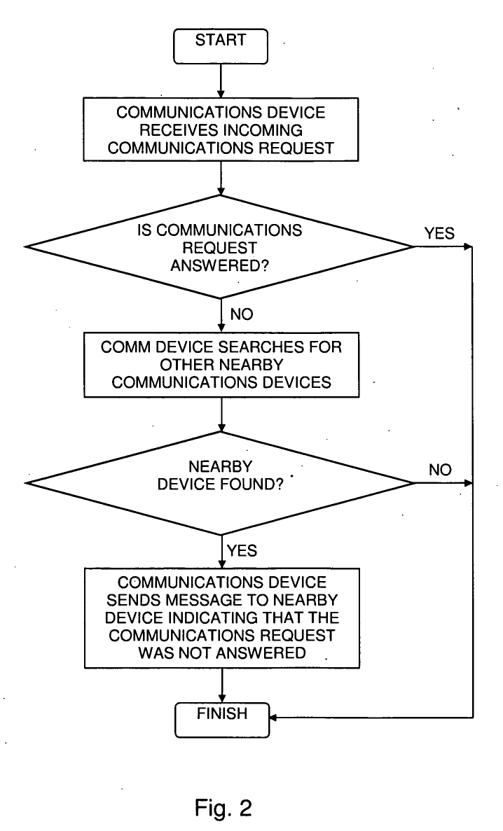

Reference is now made to FIG. 1, which is a simplified illustration of a system for reaching a communications service subscriber who does not answer an incoming communications request to the subscriber's communications device, constructed and operative in accordance with an embodiment of the present invention, and additionally to FIG. 2, which is a simplified conceptual illustration of an exemplary method of operation of the system of FIG. 1, operative in accordance with an embodiment of the invention. In the system of FIG. 1 and method of FIG. 2, an incoming communications request, such as a wireless telephone call or push-to-talk communications, is received at a communications device 100, such as may be a cellular telephone, mobile telephone, or any other known type of communications device capable of receiving an incoming communications request. Device 100 is preferably configured with a detector 106, a locator 108, and a message sender 110, whose functions are now described. If detector 106 detects that the communications request is not answered at communications device 100, such as when a user of device 100 does not answer the incoming communications request, device 100 preferably waits a predefined amount of time from when the incoming communications request is first received at device 100, or waits until the incoming communications request has terminated without being answered, such as where the caller terminates the call. Locator 108 then initiates a search to find other communications devices in the vicinity of device 100. Locator 108 preferably performs the search using any known protocol, such as Bluetooth™, that allows locator 108 to seek out other communications devices within a predefined distance from device 100. If locator 108 finds and is able to communicate with another communications device within a predefined distance from device 100, such as with a communications device 102, message sender 110 preferably sends a message, such as a Short Message Service (SMS) message, to device 102 indicating that an incoming communications request is being received at, or has just been received at, device 100. Message sender 110 may optionally indicate within the message that the incoming communications request has gone unanswered at device 100, and/or indicate within the message the identity of the initiator of the communications request if such information is available to device 100, such as via a Caller ID service. Should a user of device 102 see the message, he/she may notify a user of device 100 of the incoming communications request, such as by annunciating a verbal message to the user of device 102. Alternatively, or in addition to, sending a message to device 102, message sender 110 may initiate a communications request to device 102 and may, if the request is answered at device 102, audibly present a message, such as by playing a recorded message, indicating that an incoming communications request is being received at, or has just been received at, device 100.

In one alternative embodiment, device 100 communicates with device 102 in the manner described above only if device 102 is known to device 100, such as where the telephone number or other identifier of device 102 is stored in a list 104, such as a contact list, maintained on device 100. In another alternative embodiment, device 102 accepts communications from device 100 in the manner described above only if device 100 is known to device 102, such as where the telephone number or other identifier of device 100 is stored in a list 106, such as a contact list, maintained on device 102. In another alternative embodiment, devices 100 and 102 communicate in the manner described above only if devices 100 and 102 are known to each other as described hereinabove.

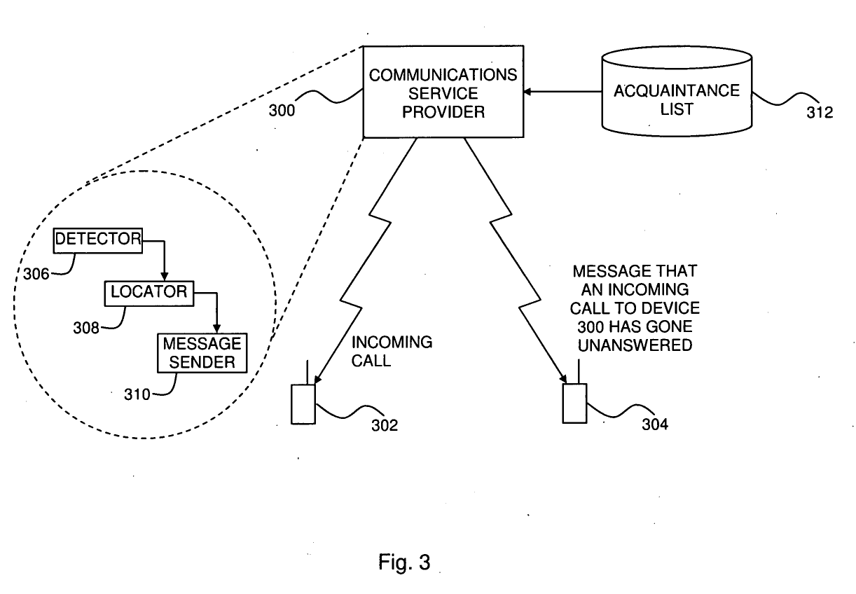

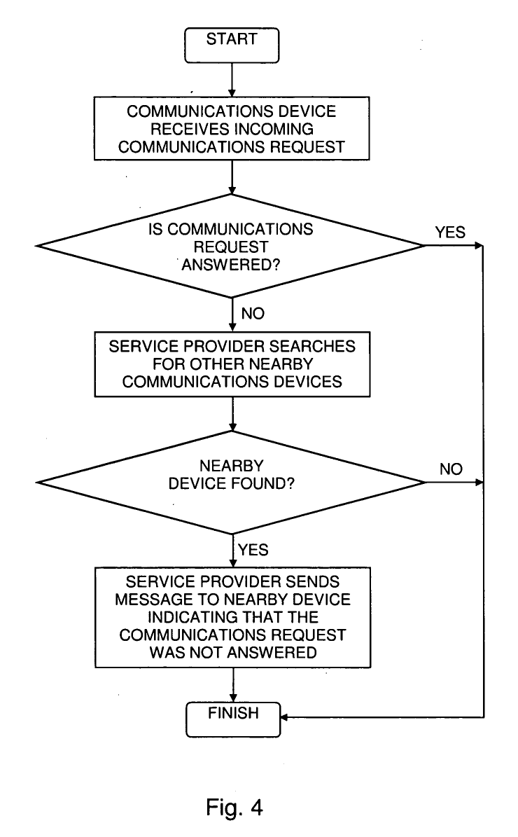

Reference is now made to FIG. 3, which is a simplified illustration of a system for reaching a communications service subscriber who does not answer an incoming communications request to the subscriber's communications device, constructed and operative in accordance with an embodiment of the present invention, and additionally to FIG. 4, which is a simplified conceptual illustration of an exemplary method of operation of the system of FIG. 3, operative in accordance with an embodiment of the invention. In the system of FIG. 3 and method of FIG. 4, a communications request, such as a wireless telephone call or push-to-talk communications, is relayed by a communications service provider 300, such as a cellular telephone carrier, to a communications device 302, such as may be a cellular telephone, mobile telephone, or any other known type of communications device capable of receiving an incoming communications request. Communications service provider 300 is preferably configured with a detector 306, a locator 308, and a message sender 310, whose functions are now described. If detector 306 detects that the communications request is not answered at communications device 302, such as when a user of device 302 does not answer the incoming communications request, communications service provider 300 preferably waits a predefined amount of time from when the communications request was first relayed to device 302, or waits until the communications request has terminated without being answered, such as where the caller terminates the call. Locator 308 then initiates a search to find other communications devices in the vicinity of device 302 using any known technique, such as by using Global Positioning System (GPS) information provided to service provider 300 by communications devices in the service area of service provider 300, or by using hyperbolic trilateration or other known techniques. If locator 308 finds and is able to communicate with another communications device within a predefined distance from device 302, such as with a communications device 304, message sender 310 preferably sends a message, such as a Short Message Service (SMS) message, to device 304 indicating that an incoming communications request is being received at, or has just been received at, device 302. Message sender 310 may optionally indicate within the message that the incoming communications request has gone unanswered, and/or indicate within the message the identity of the initiator of the communications request if such information is available to device 302, such as via a Caller ID service. Should a user of device 304 see the message, he/she may notify a user of device 302 of the incoming communications request as described above. Alternatively, or in addition to, sending a message to device 304, message sender 110 may initiate a communications request to device 304 and may, if the request is answered at device 304, audibly present a message, such as by playing a recorded message, indicating that an incoming communications request is being received at, or has just been received at, device 302.

In one alternative embodiment, service provider 300 communicates with device 304 in the manner described above only if device 304 is known to device 302, device 302 is known to device 304, or both, such as where the telephone number or other identifier of device 302 and/or device 304 is stored in an acquaintance list 312 maintained at service provider 300 which indicates which devices are acquainted with which other devices and which may be populated using any known means.

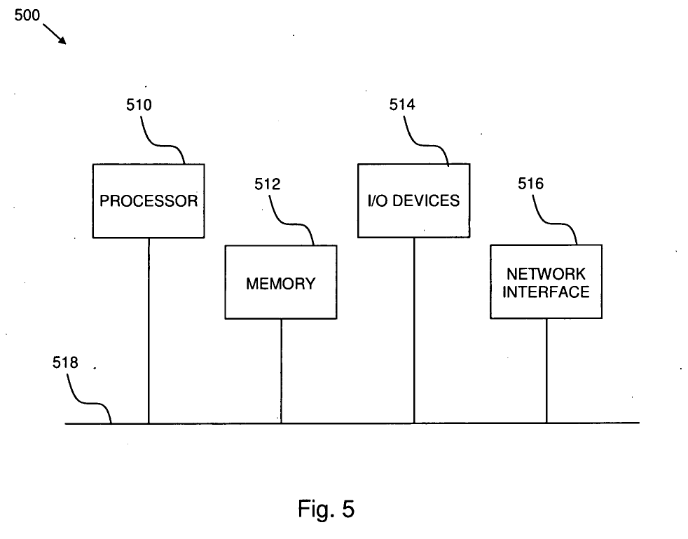

Referring now to FIG. 5, block diagram 500 illustrates an exemplary hardware implementation of a computing system in accordance with which one or more components/methodologies of the invention (e.g., components/methodologies described in the context of FIGS. 1-4) may be implemented, according to an embodiment of the present invention.

As shown, the techniques for controlling access to at least one resource may be implemented in accordance with a processor 510, a memory 512, I/O devices 514, and a network interface 516, coupled via a computer bus 518 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

What is claimed is:

1. A method for reaching a communications service subscriber who does not answer an incoming communications request to the subscriber's communications device, the method comprising:
detecting that an incoming communications request received at a first communications device is not answered;
locating a second communications device within a predefined distance from said first communications device; and
sending a message to said second communications device indicating the receipt of said incoming communications request at said first communications device.

2. A method according to claim 1 and further comprising:
initiating a communications request to said second communications device; and
audibly presenting a said message.

3. A method according to claim 1 wherein said detecting comprises detecting said incoming communications request wherein said first communications device is in the form of either of a cellular telephone and a mobile telephone.

4. A method according to claim 1 wherein any of said locating and sending are performed after a predefined amount of time has passed from when the incoming communications request is first received at said first communications device and said incoming communications request has not been answered.

5. A method according to claim 1 wherein any of said locating and sending are performed after said incoming communications request has terminated without being answered.

6. A method according to claim 1 wherein said sending step comprises sending said message in the form of a Short Message Service (SMS) message.

7. A method according to claim 1 wherein said sending step comprises sending said message including an indication that said incoming communications request has gone unanswered.

8. A method according to claim 1 wherein said sending step comprises sending said message including the identity of the initiator of said incoming communications request.

9. A method according to claim 1 wherein said sending step comprises sending said message only if said second communications device is known to said first communications device.

10. A method according to claim 1 and further comprising accepting said message at said second communications device only if said first communications device is known to said second communications device.

11. A method according to claim 1 wherein any of said detecting, locating, and sending are performed by either of said first communications device and a communications service provider.

12. A system for reaching a communications service subscriber who does not answer an incoming communications request to the subscriber's communications device, the system comprising:
a detector configured to detect that an incoming communications request received at a first communications device is not answered;
a locator configured to locate a second communications device within a predefined distance from said first communications device; and
a message sender configured to send a message to said second communications device indicating the receipt of said incoming communications request at said first communications device.

13. A system according to claim 12 wherein said message sender is configured to
initiate a communications request to said second communications device, and
audibly present a said message.

14. A system according to claim 12 wherein said detector, locator, and message sender are incorporated into either of said first communications device and a communications service provider.

15. A system according to claim 12 wherein said first communications device is in the form of either of a cellular telephone and a mobile telephone.

16. A system according to claim 12 wherein any of said locator and message sender are operative after a predefined amount of time has passed from when the incoming communications request is first received at said first communications device and said incoming communications request has not been answered.

17. A system according to claim 12 wherein any of said locator and message sender are operative after said incoming communications request has terminated without being answered.

18. A system according to claim 12 wherein said message sender is operative to send said message in the form of a Short Message Service (SMS) message.

19. A system according to claim 12 wherein said message sender is operative to send said message including an indication that said incoming communications request has gone unanswered.

20. A system according to claim 12 wherein said message sender is operative to send said message including the identity of the initiator of said incoming communications request.

21. A system according to claim 12 wherein said message sender is operative to send said message only if said second communications device is known to said first communications device.

22. A system according to claim 12 wherein said second communications device is configured to accept said message only if said first communications device is known to said second communications device.

23. A computer-implemented program embodied on a computer-readable medium, the computer program comprising:
a code segment operative to detect that an incoming communications request received at a first communications device is not answered;
a code segment operative to locate a second communications device within a predefined distance from said first communications device; and
a code segment operative to send a message to said second communications device indicating the receipt of said incoming communications request at said first communications device.
